(19) United States
(12) Patent Application Publication
(10) Pub. No.: US 2015/0124052 A1
(43) Pub. Date: May 7, 2015

(54) IMAGE PROCESSING APPARATUS, INFORMATION PROCESSING APPARATUS, AND IMAGE PROCESSING METHOD

(71) Applicant: Sony Corporation, Tokyo (JP)

(72) Inventors: Katsuhisa Ito, Tokyo (JP); Kengo Hayasaka, Kanagawa (JP); Masahiro Takada, Tokyo (JP)

(21) Appl. No.: 14/397,540

(22) PCT Filed: Apr. 24, 2013
(86) PCT No.: PCT/JP2013/002761

§ 371 Date: Oct. 28, 2014

(30) Foreign Application Priority Data
May 11, 2012 (JP) 2012-109898

(51) Int. Cl. H04N 13/00; H04N 13/02

(52) U.S. Cl. CPC H04N 13/0011; H04N 13/0203
USPC 348/46

(57) ABSTRACT

An image processing apparatus comprising an interpolation processing unit configured to generate a plurality of interpolation images based on a plurality of viewpoint images. The image processing apparatus further comprises a development processing unit configured to develop a subject image based on a development parameter and a plurality of ray vectors associated with the plurality of interpolation images and the plurality of viewpoint images.

### TECHNICAL FIELD

The present disclosure relates to an image processing apparatus, an information processing apparatus, and an image processing method that are capable of generating image data of a desired image quality by processing a plurality of viewpoint images, for example.

### BACKGROUND ART

In recent years, various imaging devices and image processing apparatuses have been proposed. For example, Patent Literature 1 below discloses an imaging device capable of generating a reconstructed image (refocused image) of a subject, which is set at an optional focus point, based on imaging data from multiple viewpoints. Further, for example, Patent Literature 2 below discloses an image processing apparatus capable of generating interpolation images from a plurality of acquired viewpoint images.

### CITATION LIST

### Patent Literature

PTL 1: Japanese Patent Application Laid-open No. 2010-183316

PTL 2: Japanese Patent Application Laid-open No. 2011-139209

### SUMMARY

### Technical Problem

In recent years, the reduction in weight, size, and thickness of a camera has been progressed. Meanwhile, a technique capable of acquiring an image that meets the demand of a user, for example, the achievement of a high-quality captured image, has been expected.

In view of the circumstances as described above, there is a need for an image processing apparatus, an information processing apparatus, and an image processing method that are capable of generating an image conforming to the intention of a user.

### Solution to Problem

According to an embodiment of the present disclosure, there is provided an image processing apparatus comprising: an interpolation processing unit configured to generate a plurality of interpolation images based on a plurality of viewpoint images; and a development processing unit configured to develop a subject image based on a development parameter and a plurality of ray vectors associated with the plurality of interpolation images and the plurality of viewpoint images.

According to another embodiment, the image processing apparatus further comprises a storage unit configured to store information on a plurality optical systems corresponding to a plurality of development parameters, wherein the development processing unit selects at least one optical system corresponding to the development parameter and generates, as the subject image, an image obtained when the ray vectors are incident on the selected at least one optical system.

According to another embodiment, the development parameter includes at least one of design information of a lens, a filter, a focus position, an aperture value, a white balance, and an exposure compensation value.

According to another embodiment, the image processing apparatus further comprises a communication unit configured to receive the plurality of viewpoint images from an information processing apparatus, and transmit the subject image to the information processing apparatus.

According to another embodiment, the development processing unit is configured to control the communication unit to transmit a plurality of selection candidates of the plurality of development parameters to the information processing apparatus, and receive a selected selection candidate from the information processing apparatus.

According to another embodiment, the development parameter is selected by a user from the plurality of development parameters.

According to another embodiment, the development processing unit is configured to develop at least one preview image based on the viewpoint images.

According to another embodiment, the image processing apparatus further comprises an imaging device configured to capture the viewpoint images; a display configured to display the subject image; and a user interface configured to set the development parameter.

According to another embodiment, the interpolation processing unit is configured to acquire depth information of the subject image based on the plurality of viewpoint images, and generate the plurality of interpolation images based on the plurality of viewpoint images and the depth information.

According to an embodiment, an image processing method is provided comprising: generating a plurality of interpolation images based on a plurality of viewpoint images; and developing a subject image based on a development parameter and a plurality of ray vectors associated with the plurality of interpolation images and the plurality of viewpoint images.

According to an embodiment, an information processing apparatus is provided comprising: an imaging unit configured to acquire a plurality of viewpoint images of a subject; and a communication unit configured to transmit the viewpoint images and a development parameter, and configured to receive a subject image based on the development parameter and a plurality of interpolation images generated using the viewpoint images.

### Advantageous Effects of Invention

As described above, according to the present disclosure, it is possible to easily generate a subject image conforming to the intention of a user.

### BRIEF DESCRIPTION OF DRAWINGS

FIG. 1 is a schematic diagram showing the configuration of a system according to an embodiment of the present disclosure.

FIG. 2 is a diagram showing a hardware configuration of a server in the system.

FIG. 3 is a block diagram showing a hardware configuration of a network terminal in the system.

FIG. 4 is a schematic perspective diagram showing one configuration example of a camera module that constitutes an imaging device in the system.

FIG. 5 is a schematic perspective diagram of a camera array that constitutes the imaging device.

FIG. 6 is a block diagram showing the configuration of a software module of the server.

FIG. 7 is a diagram showing a plurality of viewpoint images acquired by the camera array.

FIG. 8 is a diagram showing an example of interpolation images generated by the server.

FIG. 9 is a schematic perspective diagram for describing a virtual lens array.

FIG. 10 is a schematic diagram showing ray vectors of respective viewpoint images acquired by the camera array solely.

FIG. 11 is a schematic diagram showing a virtual space having ray vectors of the plurality of viewpoint images and a plurality of interpolation images.

FIG. 12 is a conceptual diagram of the virtual space shown in FIG. 11, in which an optical system corresponding to development parameters is arranged.

FIG. 13 is a conceptual diagram showing a state in which ray vectors that are incident on the optical system are sampled with use of a virtual image sensor.

FIG. 14 is a flowchart showing a basic processing procedure of the server.

FIG. 15 is a sequence diagram showing a basic operation flow of each of the server, the network terminal, and the imaging device in the system.

FIG. 16 is a flowchart showing a processing flow of each of the server, the network terminal, and the imaging device.

FIG. 17 is a flowchart showing a processing flow of each of the server and the network terminal.

FIG. 18 is a schematic diagram showing an example of a preview image generated by the server and development parameters.

FIG. 19 is a block diagram showing a hardware configuration of an information processing apparatus according to another embodiment of the present disclosure.

### DESCRIPTION OF EMBODIMENTS

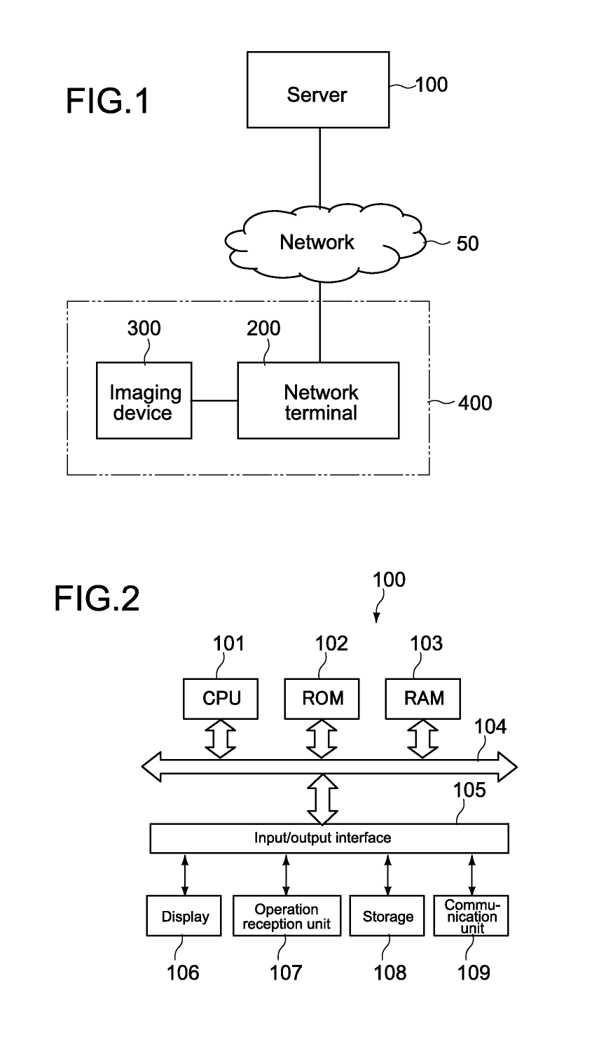

Hereinafter, embodiments of the present disclosure will be described with reference to the drawings.

[Network Configuration of System] FIG. 1 is a schematic diagram showing the configuration of a system according to an embodiment of the present disclosure.

As shown in FIG. 1, the system includes a server 100 on a cloud, a network terminal 200 of a user, and an imaging device 300.

The network terminal 200 is typically an information processing apparatus such as a PC (personal computer), a smartphone, a mobile phone, a tablet PC, and a PDA (Personal Digital Assistant).

The imaging device 300 is a digital still camera that captures a still image or a digital video camera that captures a moving image. In this embodiment, in particular, the imaging device 300 includes a camera array capable of acquiring a plurality of viewpoint images of a subject.

The network terminal 200 and the imaging device 300 are communicable with each other in a wired or wireless manner. Imaging data of a subject, which is acquired with the imaging device 300, can be transmitted to the network terminal 200. The network terminal 200 and the imaging device 300 may be a mobile terminal 400 (FIG. 1) in which the network terminal 200 and the imaging device 300 are integrated with each other.

The server 100 and network terminal 200 are communicable with each other, or the server 100 and the mobile terminal 400 are communicable with each other, on a network such as the Internet 50.

In this system, the user of the network terminal 200 can use a development processing system that is provided by the server 100. As will be described later, the server 100 has a function as an image processing apparatus that performs development processing on an image of the subject, for example, based on data of a plurality of viewpoint images transmitted from the network terminal 200.

(Hardware Configuration of Server) FIG. 2 is a diagram showing a hardware configuration of the server 100.

As shown in FIG. 2, the server 100 includes a CPU (Central Processing Unit) 101, a ROM (Read Only Memory) 102, a RAM (Random Access Memory) 103, an input/output interface 105, and a bus 104 that connects those above components with one another.

The CPU 101 functions as a controller that accesses the RAM 103 and the like as necessary and performs overall control on the whole blocks of the server 100 while performing various types of computing processing. The ROM 102 is a nonvolatile memory in which an OS to be executed by the CPU 101 and firmware such as a program and various parameters are fixedly stored. The RAM 103 is used as a work area or the like of the CPU 101 and temporarily stores the OS, various applications in execution, and various pieces of data being processed.

A display 106, an operation reception unit 107, a storage 108, a communication unit 109, and the like are connected to the input/output interface 105.

The display 106 is a display device using, for example, an LCD (Liquid Crystal Display), an OELD (Organic Electro-Luminescence Display), or a CRT (Cathode Ray Tube). The operation reception unit 107 is, for example, a pointing device such as a mouse, a keyboard, a touch panel, or another input apparatus. In the case where the operation reception unit 107 is a touch panel, the touch panel may be formed integrally with the display 106.

The storage 108 is, for example, an HDD (Hard Disk Drive), a flash memory (SSD (Solid State Drive)), or another nonvolatile memory such as a solid-state memory. The storage 108 stores the OS, various applications, and various types of data. In this embodiment, in particular, the storage 108 receives the data of the plurality of viewpoint images of the subject from the network terminal 200 (or mobile terminal 400) and stores the data therein. Further, the storage 108 stores information on various types of optical systems corresponding to a plurality of development parameters that are necessary for the development processing.

The communication unit 109 is a NIC (Network Interface Card) for connecting to the Internet 50 or a LAN (Local Area Network) by a cable or a module for wireless communication. The communication unit 109 communicates with the network terminal 200 (or mobile terminal 400). The communication unit 109 receives the plurality of viewpoint images from the network terminal 200 (or mobile terminal 400) and transmits a developed image of the subject to the network terminal 200 (or mobile terminal 400).

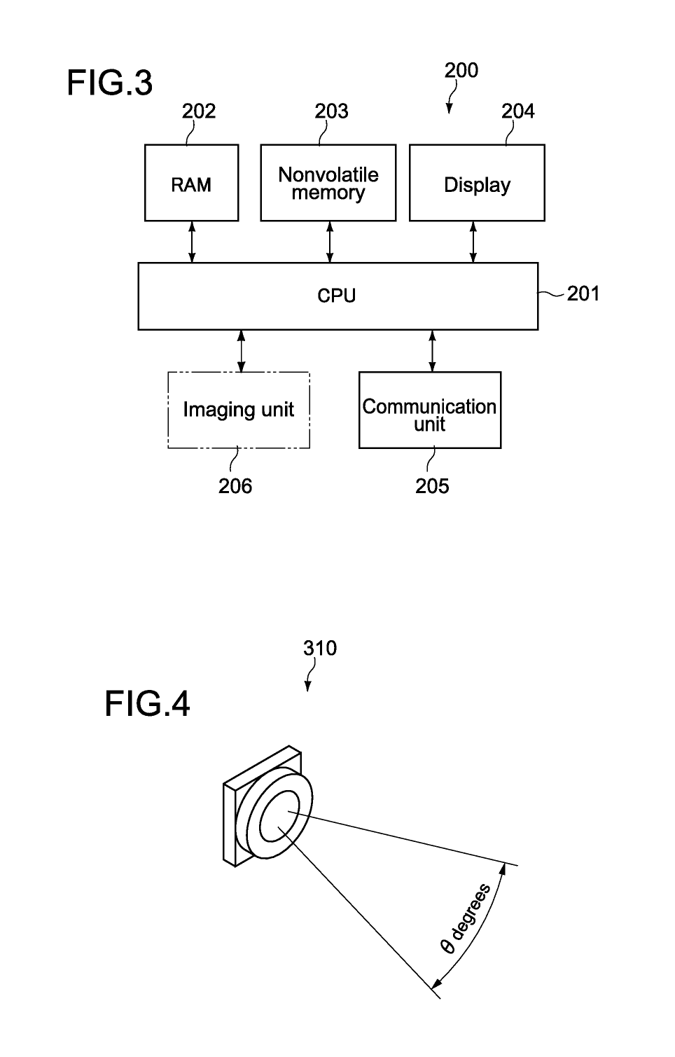

(Hardware Configuration of Network Terminal) FIG. 3 is a block diagram showing a hardware configuration of the network terminal 200.

As shown in FIG. 3, the network terminal 200 includes a CPU 201, RAM 202, a nonvolatile memory 203, a display 204, and a communication unit 205.

The CPU 201 accesses the RAM 202 and the like as necessary and performs overall control on the whole blocks of the network terminal 200 while performing various types of computing processing. The RAM 202 is used as a work area or the like of the CPU 201 and temporarily stores the OS, various applications in execution, and various pieces of data being processed.

The nonvolatile memory 203 is a flash memory or a ROM, for example, and fixedly stores an OS to be executed by the CPU 201 and firmware such as a program (application) and various parameters. Further, the nonvolatile memory 203 stores still image data (photographic data) or moving image data captured with the imaging device 300. The photographic data includes data of a plurality of viewpoint images captured by a multi-viewpoint camera that constitutes the imaging device 300, and the like.

The display 204 is an LCD or an OELD, for example, and is configured to display various menus, a GUI of an application, and the like. Typically, the display 204 is formed integrally with a touch panel and is capable of receiving a touch operation of a user.

The communication unit 205 communicates with the server 100, the imaging device 300, an adjacent portable terminal, and the like using a wireless LAN (IEEE802.11 or the like) such as Wi-Fi (Wireless Fidelity) or a 3G or 4G network for mobile communications.

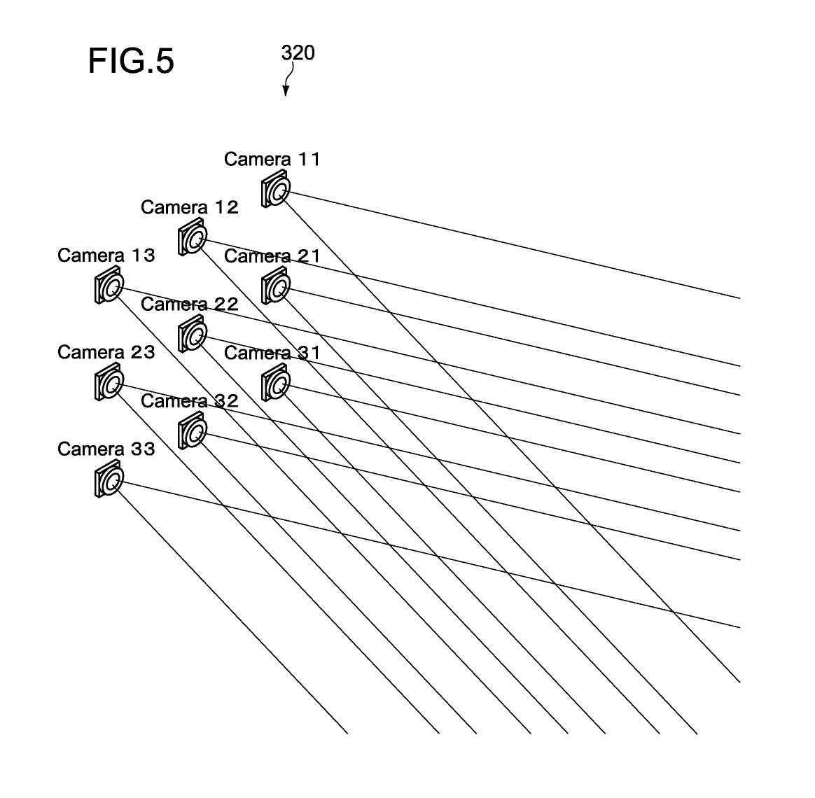

(Configuration of Imaging Device) The imaging device 300 is constituted of a camera array (multi-viewpoint camera) in which a plurality of camera modules are arranged in a matrix on a plane. FIG. 4 is a schematic perspective diagram showing one configuration example of a camera module 310. FIG. 5 is a schematic perspective diagram of a camera array 320 including a plurality of camera modules 310.

The camera module 310 is constituted of a solid-state imaging device such as a CMOS (Complementary Metal Oxide Semiconductor) sensor and a CCD (Charge Coupled Device) sensor. FIG. 5 shows an example in which nine camera modules 310 with an angle of view of Theta degrees are arranged on a plane, but the number of camera modules 310 to be arranged is not limited thereto. In the following description, the nine camera modules are also referred to as a camera 11, a camera 12, a camera 13, a camera 21, a camera 22, a camera 23, a camera 31, a camera 32, and a camera 33 as shown in FIG. 5.

In the imaging device 300, the subject is simultaneously imaged with the individual camera modules 310 so that a plurality of viewpoint images of the subject, which correspond to positions of the respective camera modules 310, are acquired. Data of the viewpoint images thus acquired is stored in the nonvolatile memory 203 via the communication unit 205 of the network terminal 200 or transmitted to the server 100 via the communication unit 205.

It should be noted that an imaging unit 206 in which the camera array is incorporated is added as a hardware configuration of the mobile terminal 400 in which the network terminal 200 and the imaging device 300 are integrated with each other, as shown in FIG. 3.

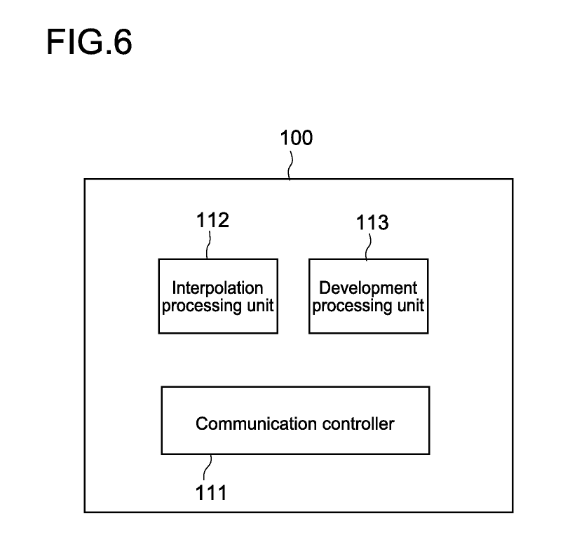

(Software Module Configuration of Server) FIG. 6 is a block diagram showing the configuration of a software module of the server 100. As shown in FIG. 6, the server 100 includes a communication controller 111, an interpolation processing unit 112, a development processing unit 113, and the like.

The communication controller 111 works in cooperation with the communication unit 109 to exchange various types of information with the network terminal 200 (or mobile terminal 400). In particular, the communication controller 111 receives inputs of subject image information and various development parameters, which are transmitted from the network terminal 200 (or mobile terminal 400). Further, the communication controller 111 may have the same function as that of a front end in a Web server. For example, the communication controller 111 may handle a basic Web operation such as an output of a main page.

(Interpolation Processing Unit)

Based on the plurality of viewpoint images transmitted from the network terminal 200 (or mobile terminal 400), the interpolation processing unit 112 generates a plurality of interpolation images that interpolate those viewpoint images. The interpolation processing unit 112 generates an intermediate image based on two adjacent viewpoint images by an interpolation technique.

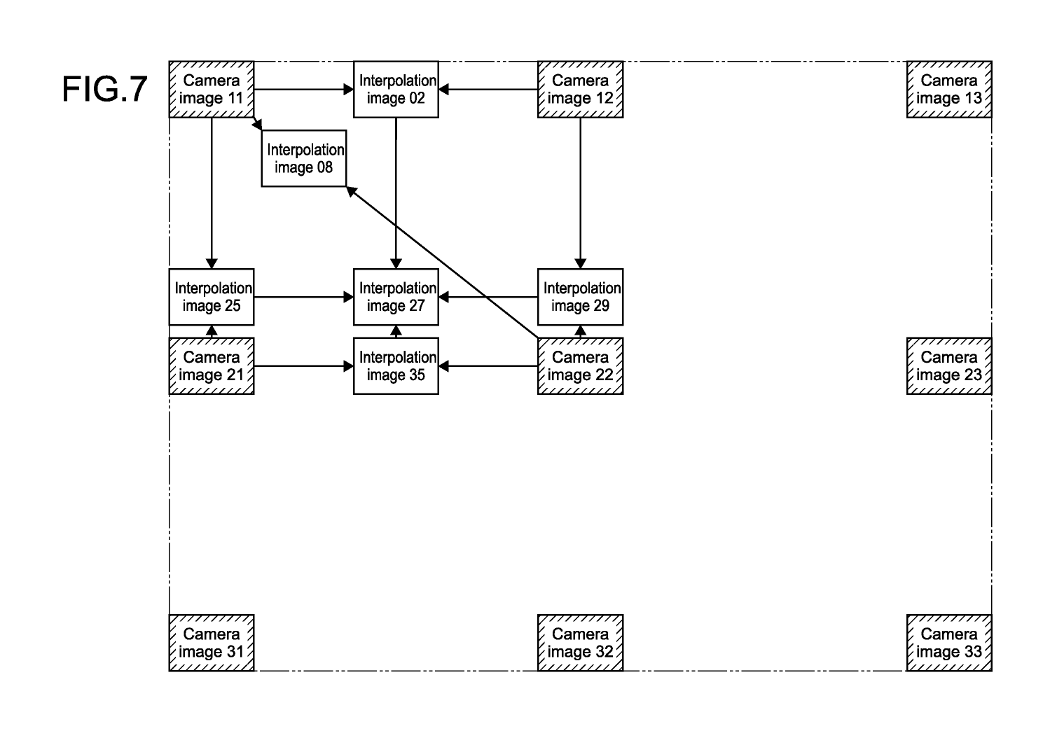

FIG. 7 shows a plurality of viewpoint images that are acquired by the camera array 320 provided in the imaging device 300 or the imaging unit 206 of a portable terminal. A camera image 11 is a viewpoint image from the camera 11, a camera image 12 is a viewpoint image from the camera 12, and a camera image 13 is a viewpoint image from the camera 13. Similarly, a camera image 21, a camera image 22, a camera image 23, a camera image 31, a camera image 32, and a camera image 33 are viewpoint images from the camera 21, the camera 22, the camera 23, the camera 31, the camera 32, and the camera 33, respectively.

The interpolation processing unit 112 generates a plurality of interpolation images that are located between those camera images. Specifically, the interpolation processing unit 112 generates an interpolation image 02 that is located on a straight line coupling the camera image 11 to the camera image 12. Similarly, the interpolation processing unit 112 generates an interpolation image 08 that is located on a straight line coupling the camera image 11 to the camera image 22. An interpolation image 27 is generated after an interpolation image 25 and an interpolation image 29, or the interpolation image 02 and an interpolation image 35 are generated.

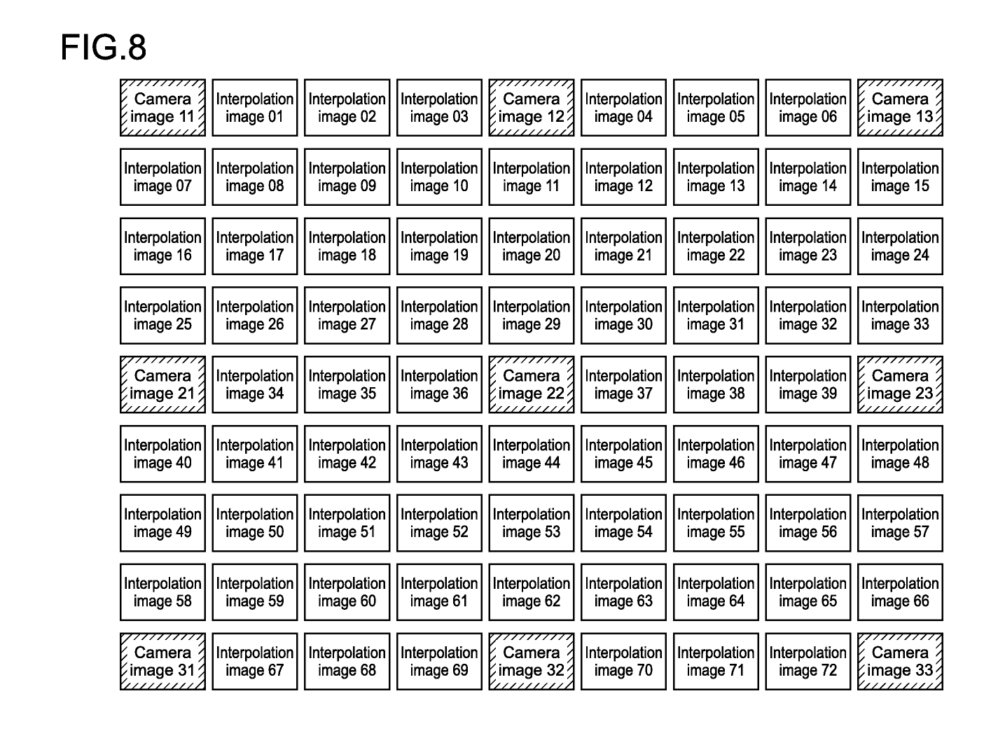

In such a manner, the interpolation processing unit 112 generates a plurality of interpolation images 01 to 72 that interpolate gaps between the camera images 11 to 33 as shown in FIG. 8. In the example described above, the case where the interpolation processing unit 112 generates three interpolation images between two of the camera images has been described, but the number of interpolation images is not limited thereto. The number of interpolation images is freely set in consideration of an image quality of a subject image to be eventually generated, a computing time, computing cost, and the like.

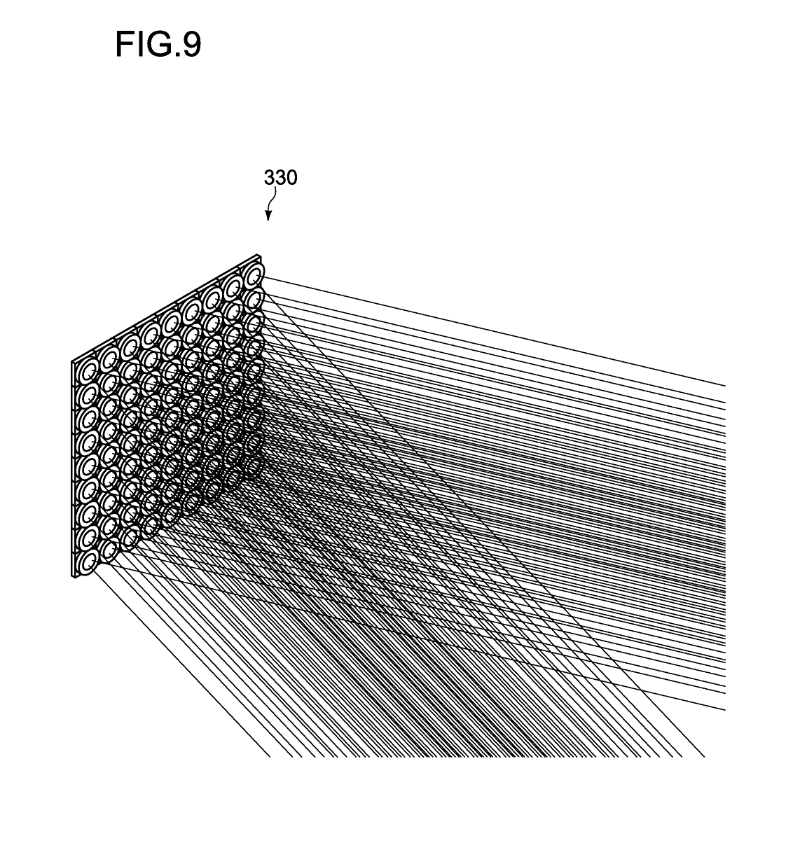

By the generation of the interpolation images 01 to 072, image information (ray information), which is similar to image information captured by a camera array 330 including many camera modules as shown in FIG. 9, can be obtained by the camera array 320 including a smaller number of camera modules. Here, assuming that horizontal and vertical resolution of one subject image is a*b pixels and such images arranged in “m” rows by “n” columns are obtained, a*b*m*n pieces of ray information that are different in angle or pass point can be sampled.

A method of generating the interpolation image is not particularly limited. In this embodiment, the interpolation processing unit 112 acquires depth information of the subject image based on the plurality of viewpoint images and generates the plurality of interpolation images based on the plurality of viewpoint images and the depth information.

The depth information is acquired by performing stereo matching a plurality of times at the left, right, top, and bottom of one viewpoint image. The stereo matching refers to an algorithm for calculating a distance. In the stereo matching, the depth information of an image is acquired by image processing using the plurality of viewpoint images each having different parallax along a certain direction (for example, horizontal direction). Specifically, two viewpoint images are compared with each other sequentially at local areas to obtain a phase difference (disparity) between the viewpoint images so that a distance is calculated based on the phase difference. A method of acquiring the depth information is not limited to the example described above. Another method such as block matching may be adopted.

(Development Processing Unit)

The development processing unit 113 develops (reconstructs) the subject image by using ray vectors of the plurality of viewpoint images and the plurality of interpolation images and a parameter selected from a plurality of development parameters.

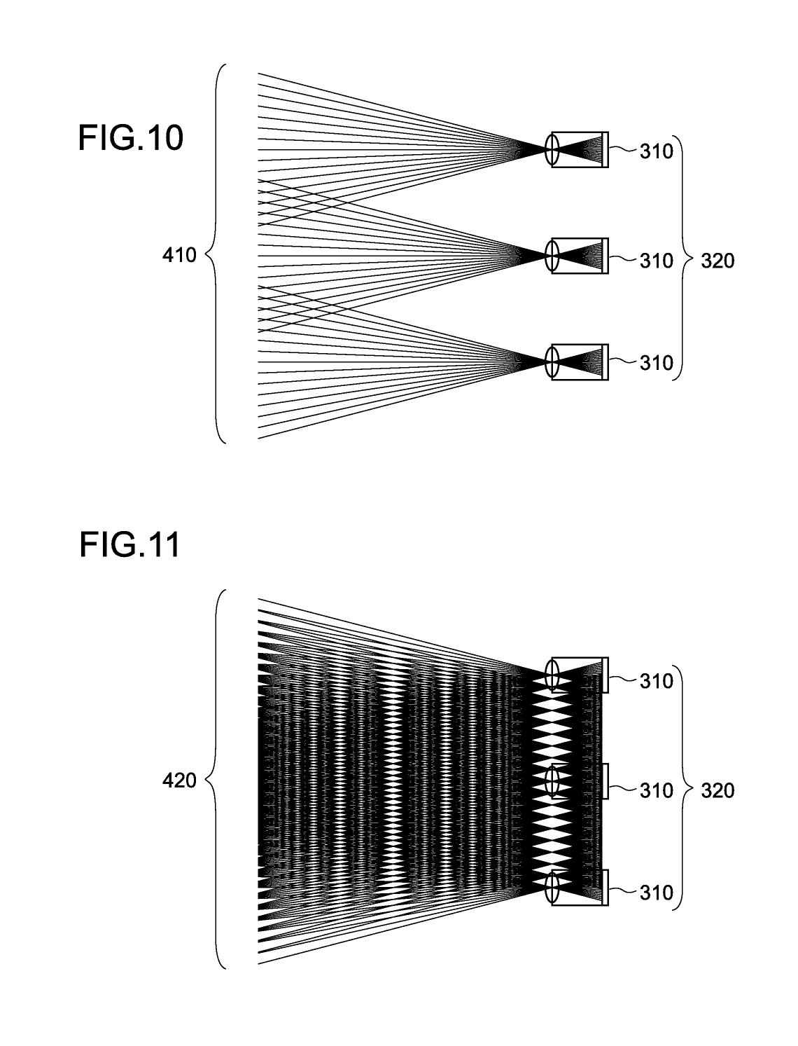

The plurality of viewpoint images acquired by the camera array 320 and the plurality of interpolation images generated by the interpolation processing unit 112 contain optical vector information from the respective viewpoints of the subject image. FIG. 10 is a schematic diagram showing ray vectors 410 of the respective viewpoint images acquired by the camera array 320 only. FIG. 11 is a schematic diagram showing a virtual space having ray vectors 420 of the plurality of viewpoint images and the plurality of interpolation images generated by interpolation processing.

The development processing unit 113 generates the subject image by executing an optical simulation using ray vector information of those ray vectors and the development parameter selected by the user. A program for executing the optical simulation and the plurality of types of development parameters that are selectable by the user are stored in the storage 108 of the server 100.

The storage 108 stores information on various types of optical systems corresponding to the plurality of development parameters. The development parameters include design information of a lens (shape, arrangement, quality of material, coating, and the like of lens), a filter, a focus position, an aperture value, a white balance, an exposure compensation value, and the like. One or a plurality of parameters of the abovementioned development parameters are selected by the user. Thus, the subject image can be developed under development conditions intended by the user.

As described above, the storage 108 stores the information on various types of optical systems corresponding to the plurality of development parameters. The development processing unit 113 selects one of the various types of optical systems whose information is stored in the storage 108 and generates, as a subject image, an image acquired when ray vectors are incident on the selected optical system.

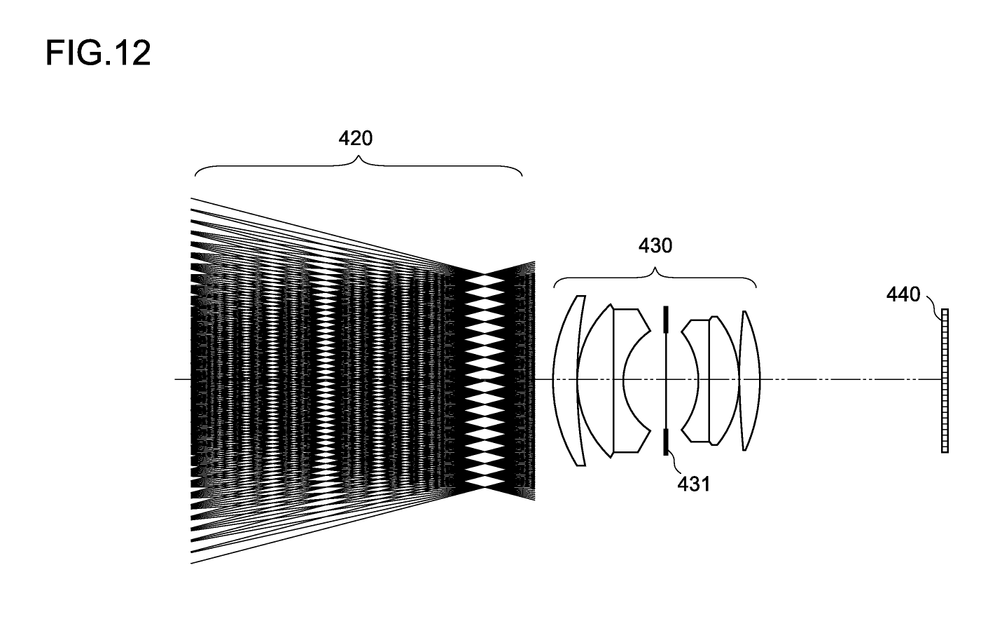

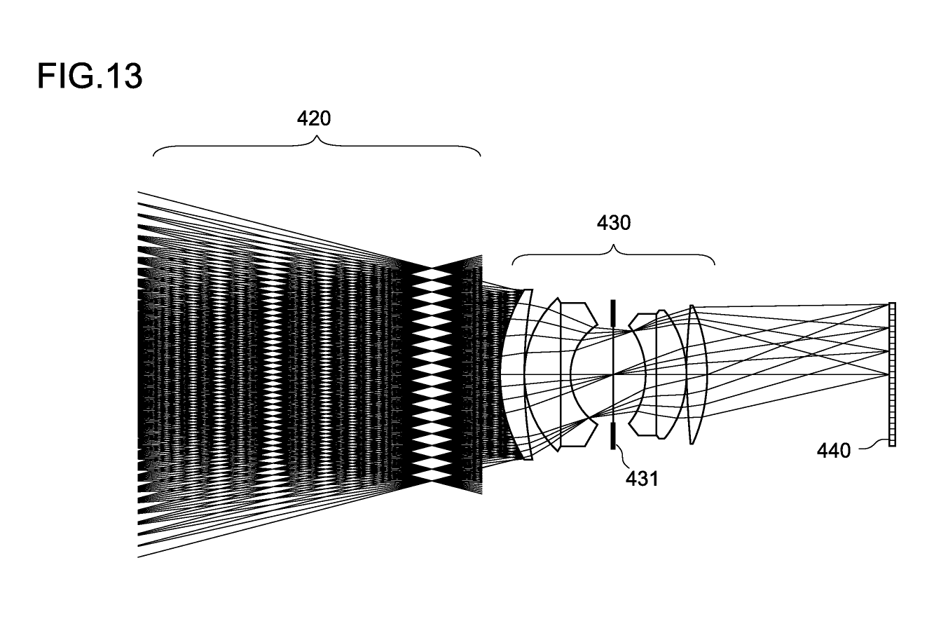

FIG. 12 is a conceptual diagram of a virtual space having the ray vectors 420, in which an optical system corresponding to development parameters (virtual lens 430, aperture 431) is arranged. FIG. 13 is a conceptual diagram showing a state in which the ray vectors 420 that are incident on the optical system of the virtual lens 430 and the aperture 431 are sampled with use of a virtual image sensor 440.

For example, if optical design information of an interchangeable lens that is produced for a certain single-lens reflex camera is obtained, information on only rays that come into an aperture plane of the interchangeable lens and penetrates inside the interchangeable lens are selected from the a*b*m*n pieces of ray information, and an optical simulation is performed to determine at which points of a virtual imaging device those rays eventually arrive. A color and a luminance of each pixel detected by the virtual imaging device are determined by analogical reasoning based on the rays reaching each pixel and the rays reaching the circumference of the pixel. In such a manner, the high-density ray information allows the focus position or the aperture to be changed any number of times using an optional lens after the imaging so that virtual imaging can be performed. Further, the high-density ray information allows reconstruction of an image whose development parameters are changed.

The development parameter is determined according to an instruction of the user. In this embodiment, the development processing unit 113 controls the communication unit 109 so that a plurality of selection candidates of the development parameters are transmitted to the network terminal 200 (or mobile terminal 400) and a selected selection candidate is received from the network terminal 200 (or mobile terminal 400).

(Summary of Processing Procedure of Server)

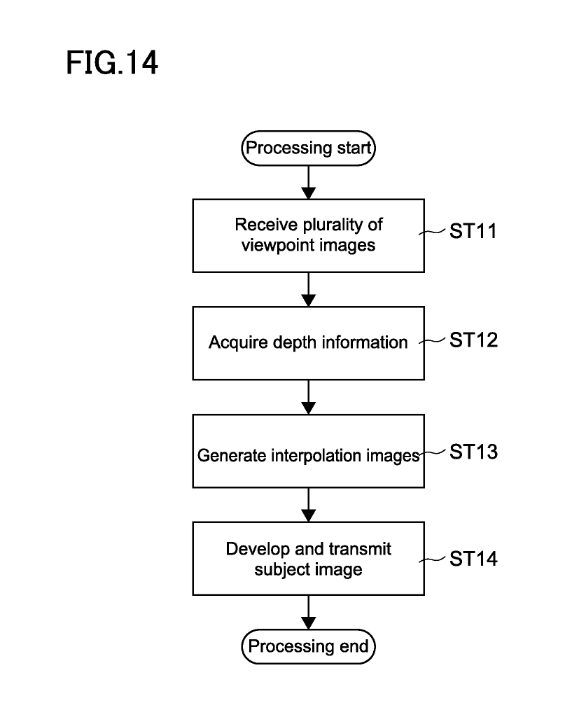

FIG. 14 is a flowchart showing a basic processing procedure of the server 100.

The server 100 performs a step of receiving a plurality of viewpoint images from the network terminal 200 (or mobile terminal 400) (ST11), the step of acquiring depth information of the images (ST12), the step of generating interpolation images (ST13), and the step of developing and transmitting a subject image to the network terminal 200 (or mobile terminal 400) (ST14). In the step of generating interpolation images, a plurality of interpolation images that interpolate the plurality of viewpoint images are generated based on the plurality of viewpoint images. In the step of developing a subject image, a subject image is developed by using the ray vectors of the plurality of viewpoint images and the plurality of interpolation images and the selected development parameter.

(Operation of System) Next, the details of the system configured as described above will be described together with the operation of each of the server 100, the network terminal 200, and the imaging device 300. In this embodiment, the operations in the server 100 and the network terminal 200 are performed in cooperation with the CPUs and the software modules executed under the control of the CPUs.

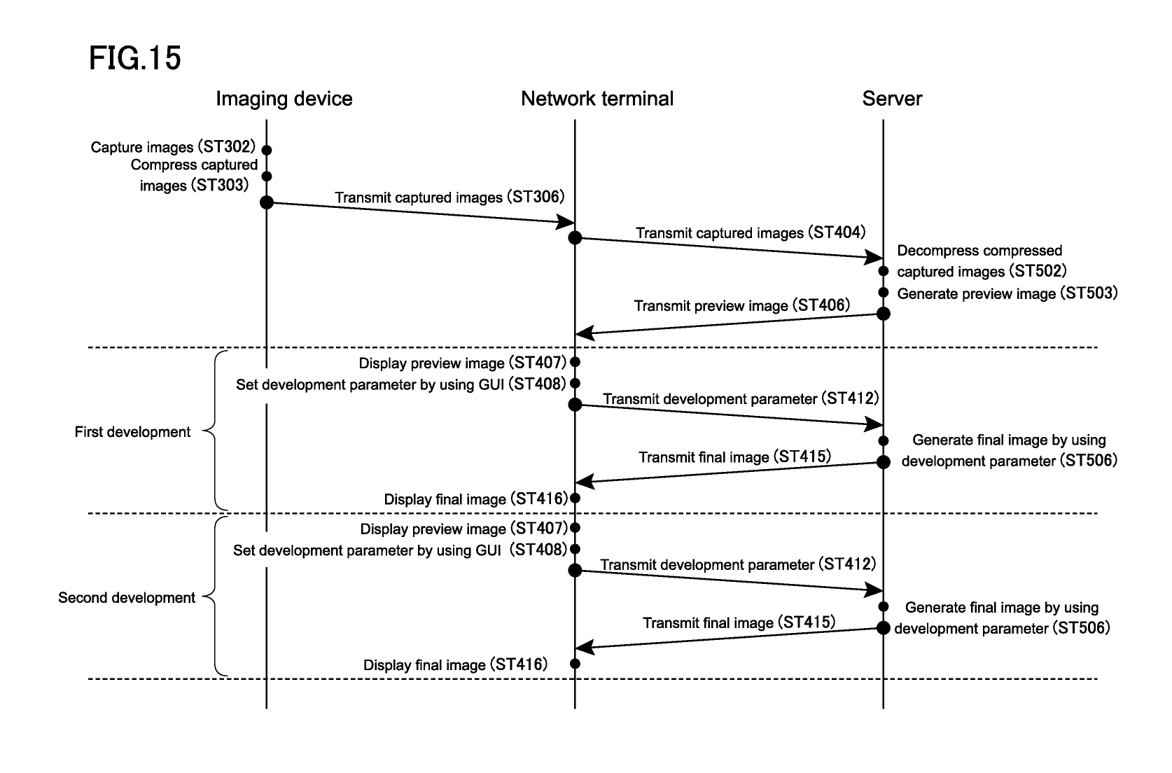

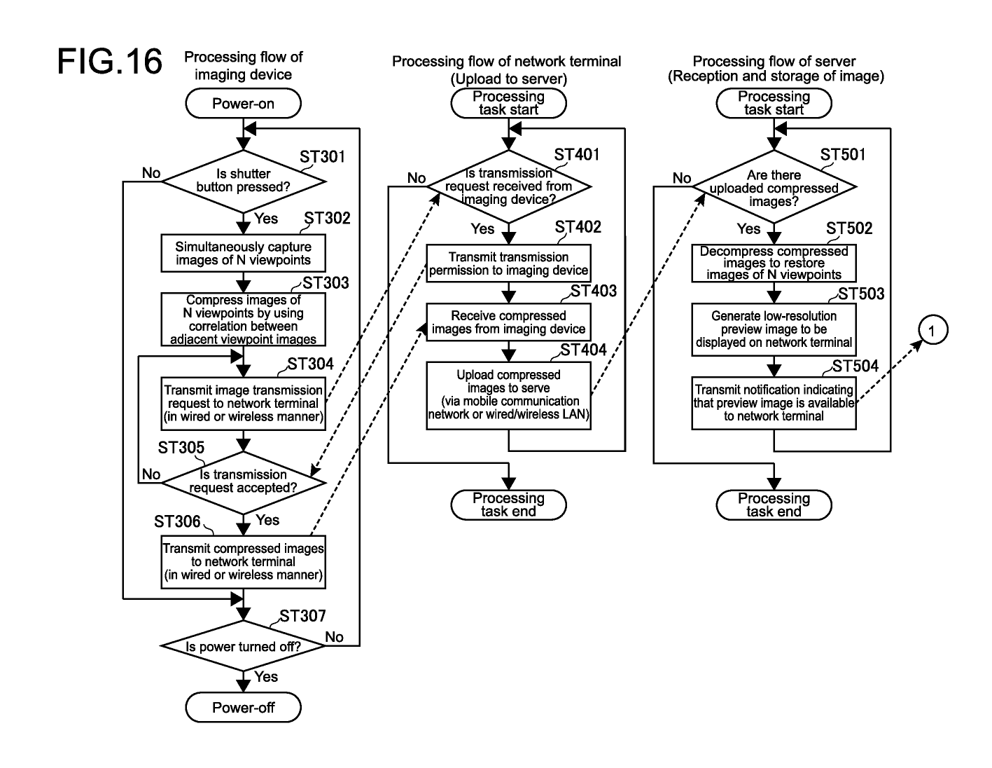

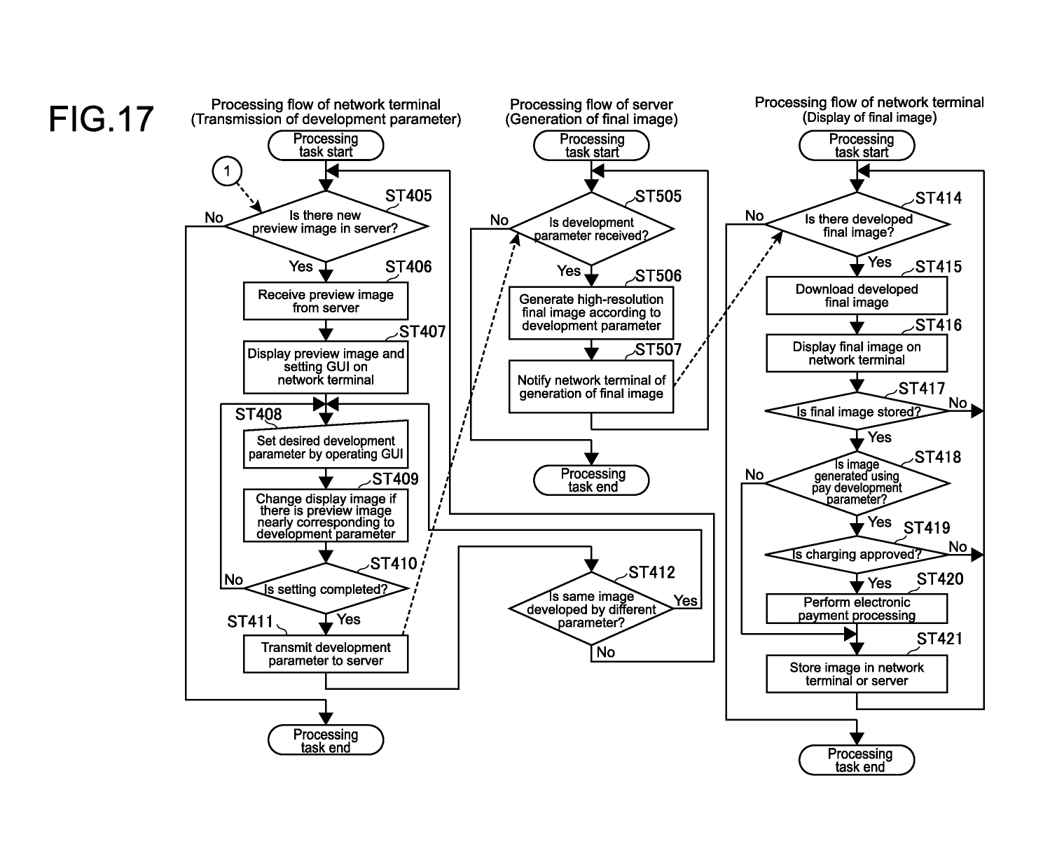

FIG. 15 is a sequence diagram showing a basic operation flow of each of the server 100, the network terminal 200, and the imaging device 300. FIG. 16 is a flowchart showing a processing flow of each of the server 100, the network terminal 200, and the imaging device 300. FIG. 17 is a flowchart showing a processing flow of each of the server 100 and the network terminal 200.

The imaging device 300 determines whether a shutter button is pressed by the user or not (Step 301). Upon press of the shutter button, the camera array 320 simultaneously captures viewpoint images of N viewpoints (in this embodiment, nine viewpoints) (Step 302).

Subsequently, the imaging device 300 compresses the acquired viewpoint images by using correlation between adjacent viewpoint images (Step 303), and transmits a image transmission request to the network terminal 200 by a wired or wireless manner (Step 304). The image transmission request is repeatedly transmitted until the image transmission request is accepted in the network terminal 200 (Step 305).

The network terminal 200 receives the image transmission request from the imaging device 300 via the communication unit 205. When receiving the image transmission request, the network terminal 200 transmits a transmission permission to the imaging device 300 (Steps 401 and 402). After receiving the transmission permission from the network terminal 200, the imaging device 300 transmits the compressed images to the network terminal 200 in the wired or wireless manner (Step 306). The imaging device 300 executes the above processing until an operation of turning off the power is performed (Step 307).

The network terminal 200 receives the compressed images of the plurality of viewpoint images from the imaging device 300 via the communication unit 205 (Step 403). The network terminal 200 stores the received compressed images in the nonvolatile memory 203. The network terminal 200 uploads (transmits) the compressed images to the server 100 via the communication unit 205 (Step 404).

In the compression processing of the viewpoint images, for example, an algorithm for compressing a moving image can be used. The plurality of viewpoint images acquired in the imaging device 300 may be transmitted to the network terminal 200 without being compressed. By the compression of the viewpoint images, the amount of data to be transmitted to the network terminal 200 can be suppressed. Alternatively, the compressed images may be generated in the network terminal 200. Thus, a processing load on the imaging device 300 can be reduced.

On the other hand, the server 100 determines whether the compressed images are uploaded to the storage 108 via the communication unit 109 (Step 501). After checking the uploaded compressed images, the server 100 decompresses the compressed images to obtain the original viewpoint images of N viewpoints, and stores the original viewpoint images in the storage 108 (Step 502).

Next, the server 100 generates a low-resolution preview image to be displayed on the display 204 of the network terminal 200 (Step 503). The preview image is generated based on the viewpoint images of N viewpoints, which are transmitted from the network terminal 200. After generating the preview image, the server 100 transmits the notification indicating that the preview image is available, to the network terminal 200 via the communication unit 205 (Step 504).

The network terminal 200 checks whether a preview image is generated in the server 100 after transmitting the compressed images to the server 100 (Step 405). Upon receiving from the server 100 the notification indicating that the preview image is ready to be transmitted, the network terminal 200 receives the preview image from the server 100 (Step 406). The received preview image is displayed on the display 204 of the network terminal 200, and the user checks the image to be developed.

The preview image is not limited to one generated by the server 100 as described above, and may be generated by the network terminal 200, for example. Further, only one preview image may be generated or some sample images with changed development parameters may be generated.

The server 100 transmits the development parameter to the network terminal 200 when or after the preview image is transmitted, and the network terminal 200 displays the transmitted development parameter on the display 204 (Step 407). Thus, a highly convenient development service can be provided to the user.

The development parameter may be a GUI (Graphical User Interface) on which the preview image is superimposed, for example. Upon reception of a selection operation by the user, the network terminal 200 sets the development parameter desired by the user (Step 408). In the case where a plurality of sample images are prepared as preview images, the network terminal 200 may change a display screen to display a preview image nearly corresponding to the selected development parameter (Step 409). After the completion of the setting of the development parameter, the network terminal 200 transmits the development parameter to the server 100 (Steps 410 and 411).

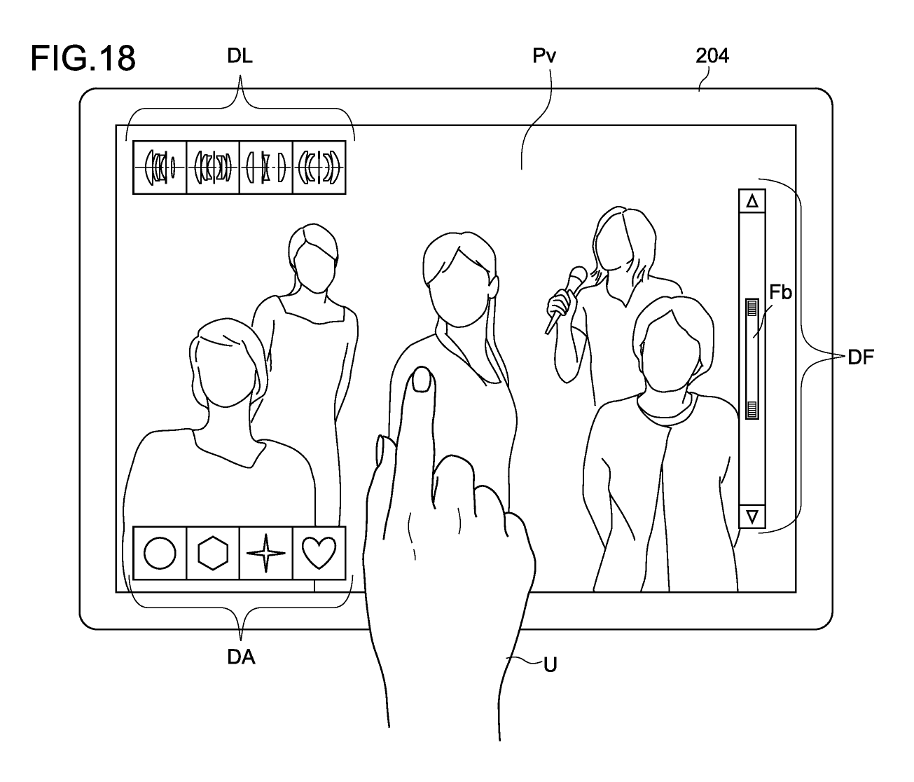

FIG. 18 is a schematic diagram showing an example of a preview image Pv and development parameters, which are displayed on the display 204. In this example, the display 204 includes a touch panel and is configured such that a development parameter is selected by a touch operation of a user U. As the development parameters, a selection candidate DL of a lens unit, a selection candidate DA of an aperture shape, a focus position setting section DF, and the like are displayed.

In the selection candidate DL of the lens unit, profile data of some optical lens units that can be used for development are displayed as figures and selected by a touch operation of the user U. In the selection candidate DA of the aperture shape, shapes of some apertures that can be used for development are displayed as figures and selected by a touch operation of the user U. The focus position setting section DF sets a focus position within the image by vertically moving a setting bar Fb in FIG. 18. The focus position may be set at a touched position of the user U within the screen. In this case, the setting bar may be moved in conjunction with the touched position.

As the selection candidate DL of the lens unit, various types of profile data of not only a currently available lens unit but also a rare lens or a virtual lens that is physically difficult to produce can be prepared. In this regard, in the case where an image is reconstructed with use of a special lens that attracts the interest of a user, a fee of the profile data may be charged.

Selection images of the development parameters (DL, DA, DF) may be displayed at any positions within the screen of the display 204. Further, as the development parameters, GUIs with which a white balance, an exposure compensation value, and the like can be adjusted may be displayed together. Alternatively, in the development parameters, a pay parameter may be set. Further, the selection of the development parameter is not limited to a selection by a touch operation of the user. The development parameter may be selected by a movement and selection operation of a pointer that is moved by a mouse operation within the screen.

On the other hand, in the case where the user requests a generation of the subject image by using a development parameter different from the selected development parameter, the network terminal 200 may receive a selection of the development parameter different from the set development parameter (Step 412). In this case, the newly set development parameter is transmitted to the server 100 through the processing described above (Steps 408 to 411).

After receiving the development parameter from the network terminal 200, the server 100 generates a high-resolution final image according to the development parameter (Step 506). The final image is generated through the steps of acquiring depth information and generating interpolation images (Steps 12 and 13) and the step of developing a subject image using ray vector information of viewpoint images and interpolation images and the selected development parameter (Step 14), as shown in FIG. 14. In other words, the server 100 performs interpolation processing on the uploaded viewpoint images to convert the uploaded viewpoint images into high-density ray information. Further, the server 100 executes an optical simulation using the development parameter such as set profile data of a lens, to generate a final image.

The server 100 notifies the network terminal 200 of the generation of a final image (subject image) (Step 507). Upon reception of the notification from the server 100, the network terminal 200 downloads the generated final image (Steps 414 and 415). The network terminal 200 displays the downloaded final image on the display 204 so that the user can view the image (Step 416). Further, the network terminal 200 checks with the user whether the image is stored or not (Step 417). The selection as to whether the image is stored or not may be displayed on the display 204.

In the case where the development parameter selected by the user is a pay development parameter, the network terminal 200 displays on the display 204 a message for seeking an approval for charging (Steps 418 and 419). In the case where the user approves the charging, the network terminal 200 performs necessary electronic payment processing and then stores the downloaded final image in the nonvolatile memory 203 of the network terminal 200 or in the storage 108 of the server 100 (Step 421). On the other hand, in the case where the development parameter is free of charge, a fee is not charged and the storage processing described above is executed.

Upon reception of a different type of development parameter again, the server 100 executes the processing described above again to generate a final image (second development). In this case, the network terminal 200 executes the processing described above again and executes the storage of the final image and the electronic payment processing as necessary.

As described above, in this embodiment, the server 100 is configured as an image processing apparatus including the interpolation processing unit 112 and the development processing unit 113. With the image processing apparatus, it is possible to generate such an image that is obtained when a large number of viewpoint images are used. Thus, a subject image conforming to the intention of the user can be easily generated.

In this embodiment, the server 100 on the cloud is used to develop the subject image captured with the imaging device 300. Thus, it is unnecessary for the imaging device to perform a large amount of computing processing such as interpolation processing and development processing, which are performed in the server 100, with the result that the cost and power consumption of the imaging device can be reduced. Further, since the imaging device 300 and the network terminal 200 that functions as a viewer are separated from each other, the imaging with use of an easily portable imaging device can be flexibly performed.

According to this embodiment, the focus position or the aperture can be set after the subject is imaged. Therefore, even if the image is blurred or there is an error in the setting of the depth of field, a high-quality subject image conforming to the intention of the user can be obtained.

According to this embodiment, the plurality of development parameters necessary for development are prepared in the server 100. Therefore, it is unnecessary to carry a heavy, voluminous interchangeable lens, with the result that an image equivalent to one captured using some interchangeable lenses can be acquired after the imaging. Further, it is unnecessary to mount a heavy, voluminous lens unit onto the imaging device 300, with the result that a high-quality image can be captured even with a small, light, thin imaging device.

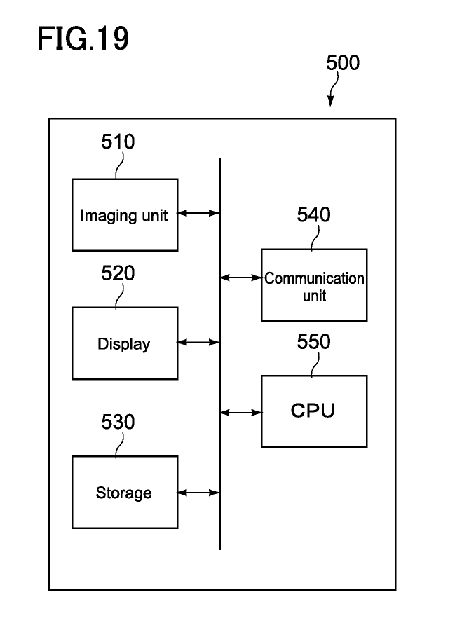

FIG. 19 is a block diagram showing a hardware configuration of an information processing apparatus according to another embodiment of the present disclosure.

In this embodiment, an example in which the system described in the first embodiment is constituted of a single information processing apparatus 500 will be described. The information processing apparatus 500 includes an imaging unit 510, a display 520, a storage 530, a communication unit 540, and a CPU 550.

The imaging unit 510 corresponds to the imaging device 300 or the imaging unit 206 described in the first embodiment and includes a multi-viewpoint camera capable of capturing a plurality of viewpoint images.

The display 520 is used for displaying a preview image of a subject, which is generated based on the plurality of viewpoint images acquired with the imaging unit 510, for setting a development parameter, for displaying a final image of a subject image generated by computing processing of the CPU 550, and the like.

The storage 530 stores the plurality of viewpoint images acquired with the imaging unit 510, a plurality of development parameters, interpolation images generated by the computing processing of the CPU 550, the final image, and the like. The development parameters stored in the storage 530 may be downloaded via the communication unit 540 or may be read from a memory card in which the development parameters are stored.

The communication unit 540 is configured to communicate with an external network terminal or a server apparatus on a network.

The CPU 550 controls the operation of each of the imaging unit 510, the display 520, the storage 530, and the communication unit 540. The CPU 550 generates a plurality of interpolation images that interpolate the plurality of viewpoint images based on the plurality of viewpoint images. The CPU 550 develops the subject image by using ray vectors of the plurality of viewpoint images and the interpolation images and a development parameter that is stored in the storage 530 and selected by the user. The interpolation processing, the development processing, and the like of the viewpoint images by the CPU 550 are the same as those of the server 100 described in the first embodiment above, and therefore a description thereof will be omitted here.

Also in the information processing apparatus 500 of this embodiment, the same action and effects as those in the first embodiment described above can be obtained.

Although the embodiments of the present disclosure has been described hereinabove, the present disclosure is not limited to the embodiments described above and may be variously modified without departing from the gist of the present disclosure as a matter of course.

For example, in the embodiments described above, a low-resolution preview image generated using the viewpoint images of N viewpoints is generated as a preview image. However, the preview image may be generated using high-resolution image data that has been subjected to the interpolation processing.

Further, a method of setting the development parameter is not limited to a selection operation using the GUI. An analog setting of parameters, which involves an operation of inputting a numerical value, may also be performed.

Further, regarding the lens design information of the development parameters stored in the storage 108 of the server 100, lens design information generally used may be managed in the cloud server 100, and a name or type of the lens may be managed or selected in the network terminal 200.

Further, the lens design information may be recorded in a memory card and the memory card may be mounted into the imaging device 300 or the network terminal 200 so that a necessary development parameter can be set.

In the embodiments described above, the example in which the subject image is reconstructed from the plurality of viewpoint images in the optical system designated by the user has been described, but a three-dimensional (3D) image may be generated from the plurality of viewpoint images.

In addition, in the embodiments described above, the interpolation processing and the development processing of the viewpoint images are performed by the server 100, but the present disclosure is not limited thereto. The interpolation processing and the development processing of the viewpoint images described above may be performed by the network terminal 200.

It should be noted that the present disclosure can take the following configurations.

(1) An image processing apparatus, including:

an interpolation processing unit configured to generate a plurality of interpolation images based on a plurality of viewpoint images, the plurality of interpolation images interpolating the plurality of viewpoint images;

a storage configured to store a plurality of development parameters; and

a development processing unit configured to develop a subject image by using ray vectors of the plurality of viewpoint images and the plurality of interpolation images and a parameter selected from the plurality of development parameters.

(2) The image processing apparatus according to (1), in which

the storage is configured to store information on a plurality of types of optical systems corresponding to the plurality of development parameters, and

the development processing unit is configured to

select one optical system from the plurality of types of optical systems whose information is stored in the storage, and

generate, as the subject image, an image obtained when the ray vectors are incident on the selected optical system.

(3) The image processing apparatus according to (1) or (2), in which

the interpolation processing unit is configured to

acquire depth information of the subject image based on the plurality of viewpoint images, and

generate the plurality of interpolation images based on the plurality of viewpoint images and the depth information.

(4) The image processing apparatus according to any one of (1) to (3), further including a communication unit configured to receive the plurality of viewpoint images from an information processing apparatus and transmit the subject image to the information processing apparatus.

(5) The image processing apparatus according to (4), in which

the development processing unit is configured to control the communication unit to transmit a selection candidate of the plurality of development parameters to the information processing apparatus and receive the selected selection candidate from the information processing apparatus.

(6) The image processing apparatus according to (5), in which

the selection candidate includes at least one of information on a lens, a focus position,

and an aperture value that constitute an optical system corresponding to the parameter.

(7) An information processing apparatus, including:

an imaging unit configured to capture a plurality of viewpoint images; and

a controller configured to

generate a plurality of interpolation images based on the plurality of viewpoint images, the plurality of interpolation images interpolating the plurality of viewpoint images, and

develop a subject image by using ray vectors of the plurality of viewpoint images and the plurality of interpolation images and a development parameter selected in advance.

(8) An information processing apparatus, including:

a communication unit configured to communicate with a server; and

a controller configured to control the communication unit to

transmit a plurality of viewpoint images and a development parameter selected by a user to a server, and

receive from the server a subject image generated by the server by using ray vectors of the plurality of viewpoint images and a plurality of interpolation images that interpolate the plurality of viewpoint images and the selected development parameter.

(9) The information processing apparatus according to (8), further including an imaging unit configured to acquire the plurality of viewpoint images.

(10) An image processing method, including:

acquiring a plurality of viewpoint images by using a multi-viewpoint camera;

generating a plurality of interpolation images based on the plurality of viewpoint images, the plurality of interpolation images interpolating the plurality of viewpoint images;

selecting a development parameter; and

developing a subject image by using ray vectors of the plurality of viewpoint images and the plurality of interpolation images and the selected development parameter.

(11) An image processing apparatus comprising:

an interpolation processing unit configured to generate a plurality of interpolation images based on a plurality of viewpoint images; and

a development processing unit configured to develop a subject image based on a development parameter and a plurality of ray vectors associated with the plurality of interpolation images and the plurality of viewpoint images.

(12) An image processing apparatus according to (11), further comprising:

a storage unit configured to store information on a plurality optical systems corresponding to a plurality of development parameters,

wherein the development processing unit selects at least one optical system corresponding to the development parameter and generates, as the subject image, an image obtained when the ray vectors are incident on the selected at least one optical system.

(13) An image processing apparatus according to (11) or (12), wherein the development parameter includes at least one of design information of a lens, a filter, a focus position, an aperture value, a white balance, and an exposure compensation value.

(14) An image processing apparatus according to any one of (11), (12), and (13), further comprising:

a communication unit configured to receive the plurality of viewpoint images from an information processing apparatus, and transmit the subject image to the information processing apparatus.

(15) An image processing apparatus according to (14), wherein the development processing unit is configured to control the communication unit to transmit a plurality of selection candidates of the plurality of development parameters to the information processing apparatus, and receive a selected selection candidate from the information processing apparatus.

(16) An image processing apparatus according to anyone of (11), (12), (13), (14), and (15), wherein the development parameter is selected by a user from the plurality of development parameters.

(17) An image processing apparatus according to anyone of (11), (12), (13), (14), (15), and (16), wherein the development processing unit is configured to develop at least one preview image based on the viewpoint images.

(18) An image processing apparatus according to anyone of (11), (12), (13), (14), (15), (16), and (17), further comprising:

an imaging device configured to capture the viewpoint images;

a display configured to display the subject image; and

a user interface configured to set the development parameter.

(19) An image processing apparatus according to anyone of (11), (12), (13), (14), (15), (16), (17), and (18), wherein the interpolation processing unit is configured to acquire depth information of the subject image based on the plurality of viewpoint images, and generate the plurality of interpolation images based on the plurality of viewpoint images and the depth information.

(20) An image processing method comprising:

generating a plurality of interpolation images based on a plurality of viewpoint images; and

developing a subject image based on a development parameter and a plurality of ray vectors associated with the plurality of interpolation images and the plurality of viewpoint images.

(21) An image processing method according to (20), further comprising: storing information on a plurality optical systems corresponding to a plurality of development parameters;

selecting at least one optical system corresponding to the development parameter; and

generating, as the subject image, an image obtained when the ray vectors are incident on the selected at least one optical system.

(22) An image processing method according to (20) or (21), wherein the development parameter includes at least one of design information of a lens, a filter, a focus position, an aperture value, a white balance, and an exposure compensation value.

(23) An image processing method according to any one of (20), (21), and (22), further comprising:

receiving the plurality of viewpoint images from an information processing apparatus via a communication unit, and

transmitting the subject image to the information processing apparatus via the communication unit.

(24) An image processing method according to (23), further comprising:

controlling the communication unit to transmit a plurality of selection candidates of the plurality of development parameters to the information processing apparatus, and receive a selected selection candidate from the information processing apparatus.

(25) An image processing method according to any one of (20), (21), (22), (23), and (24), wherein the development parameter is selected by a user from the plurality of development parameters.

(26) An image processing method according to any one of (20), (21), (22), (23), (24), and (25), further comprising:

developing at least one preview image based on the viewpoint images.

(27) An image processing method according to any one of (20), (21), (22), (23), (24), (25), and (26), further comprising:

capturing the viewpoint images;

displaying the subject image; and

selecting the development parameter via a user interface.

(28) An image processing method according to any one of (20), (21), (22), (23), (24), (25), (26), and (27), further comprising:

acquiring depth information of the subject image based on the plurality of viewpoint images; and

generating the plurality of interpolation images based on the plurality of viewpoint images and the depth information.

(29) An information processing apparatus comprising:

an imaging unit configured to acquire a plurality of viewpoint images of a subject; and

a communication unit configured to transmit the viewpoint images and a development parameter, and configured to receive a subject image based on the development parameter and a plurality of interpolation images generated using the viewpoint images.

(30) An information processing apparatus according to (29), further comprising:

a user interface configured to select the development parameter from a plurality of development parameters.

(31) An information processing apparatus according to (29) or (30), further comprising:

a storage unit configured to store information on a plurality optical systems corresponding to a plurality of development parameters,

wherein at least one optical system corresponding to the development parameter is selected, and the subject image is generated as an image obtained when the ray vectors are incident on the selected at least one optical system.

The present application contains subject matter related to that disclosed in Japanese Priority Patent Application JP 2012-109898 filed in the Japan Patent Office on May 11, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 server
108 storage
112 interpolation processing unit
113 development processing unit
200 network terminal
300 imaging device
500 information processing apparatus

1. An image processing apparatus comprising:
an interpolation processing unit configured to generate a plurality of interpolation images based on a plurality of viewpoint images; and
a development processing unit configured to develop a subject image based on a development parameter and a plurality of ray vectors associated with the plurality of interpolation images and the plurality of viewpoint images.

2. An image processing apparatus according to claim 1, further comprising:
a storage unit configured to store information on a plurality optical systems corresponding to a plurality of development parameters, wherein the development processing unit selects at least one optical system corresponding to the development parameter and generates, as the subject image, an image obtained when the ray vectors are incident on the selected at least one optical system.

3. An image processing apparatus according to claim 2, wherein the development parameter includes at least one of design information of a lens, a filter, a focus position, an aperture value, a white balance, and an exposure compensation value.

4. An image processing apparatus according to claim 1, further comprising:
a communication unit configured to receive the plurality of viewpoint images from an information processing apparatus, and transmit the subject image to the information processing apparatus.

5. An image processing apparatus according to claim 4, wherein the development processing unit is configured to control the communication unit to transmit a plurality of selection candidates of the plurality of development parameters to the information processing apparatus, and receive a selected selection candidate from the information processing apparatus.

6. An image processing apparatus according to claim 2, wherein the development parameter is selected by a user from the plurality of development parameters.

7. An image processing apparatus according to claim 1, wherein the development processing unit is configured to develop at least one preview image based on the viewpoint images.

8. An image processing apparatus according to claim 1, further comprising:
an imaging device configured to capture the viewpoint images;
a display configured to display the subject image; and
a user interface configured to set the development parameter.

9. An image processing apparatus according to claim 1, wherein the interpolation processing unit is configured to acquire depth information of the subject image based on the plurality of viewpoint images, and generate the plurality of interpolation images based on the plurality of viewpoint images and the depth information.

10. An image processing method comprising:
generating a plurality of interpolation images based on a plurality of viewpoint images; and
developing a subject image based on a development parameter and a plurality of ray vectors associated with the plurality of interpolation images and the plurality of viewpoint images.

11. An image processing method according to claim 10, further comprising:
storing information on a plurality optical systems corresponding to a plurality of development parameters;
selecting at least one optical system corresponding to the development parameter; and
generating, as the subject image, an image obtained when the ray vectors are incident on the selected at least one optical system.

12. An image processing method according to claim 11, wherein the development parameter includes at least one of design information of a lens, a filter, a focus position, an aperture value, a white balance, and an exposure compensation value.

13. An image processing method according to claim 10, further comprising:
receiving the plurality of viewpoint images from an information processing apparatus via a communication unit, and
transmitting the subject image to the information processing apparatus via the communication unit.

14. An image processing method according to claim 13, further comprising:
controlling the communication unit to transmit a plurality of selection candidates of the plurality of development parameters to the information processing apparatus, and receive a selected selection candidate from the information processing apparatus.

15. An image processing method according to claim 10, further comprising:
developing at least one preview image based on the viewpoint images.

16. An image processing method according to claim 10, further comprising:
capturing the viewpoint images;
displaying the subject image; and
selecting the development parameter via a user interface.

17. An image processing method according to claim 10, further comprising:
acquiring depth information of the subject image based on the plurality of viewpoint images; and
generating the plurality of interpolation images based on the plurality of viewpoint images and the depth information.

18. An information processing apparatus comprising:
an imaging unit configured to acquire a plurality of viewpoint images of a subject; and
a communication unit configured to transmit the viewpoint images and a development parameter, and configured to receive a subject image based on the development parameter and a plurality of interpolation images generated using the viewpoint images.

19. An information processing apparatus according to claim 19, further comprising:
a user interface configured to select the development parameter from a plurality of development parameters.

20. An information processing apparatus according to claim 19, further comprising:
a storage unit configured to store information on a plurality optical systems corresponding to a plurality of development parameters, wherein at least one optical system corresponding to the development parameter is selected, and the subject image is generated as an image obtained when the ray vectors are incident on the selected at least one optical system.
